(19) United States
(12) Patent Application Publication
(10) Pub. No.: US 2025/0082154 A1
(43) Pub. Date: Mar. 13, 2025

(54) FILTER CLEANING UNIT, VACUUM CLEANER AND METHOD FOR CLEANING A FILTER IN A VACUUM CLEANER

(71) Applicant: Hilti Aktiengesellschaft, Schaan (LI)

(72) Inventors: Roman PODHORNY, Buchloe (DE); John Van TAACK-TRAKRANEN, Muenchen (DE); Xaver HANSLMEIER, Mauerstettten (DE)

(21) Appl. No.: 18/718,222

(22) PCT Filed: Dec. 7, 2022
(86) PCT No.: PCT/EP2022/084745

§ 371 Date: Jun. 10, 2024

(30) Foreign Application Priority Data
Dec. 22, 2021 (EP) 21216764.7

(51) Int. Cl. A47L 9/20; A47L 5/20; A47L 9/12; B01D 46/42; B01D 46/762

(52) U.S. Cl. CPC A47L 9/20; A47L 5/20; A47L 9/12; B01D 46/4272; B01D 46/762; B01D 2273/28; B01D 2273/30; B01D 2279/55

(57) ABSTRACT

A filter cleaning unit for a vacuum cleaner is provided, in particular a construction site vacuum cleaner, wherein the vacuum cleaner includes a turbine for generating a suction air flow and a filter for filtering the suction air flow. A suction channel is provided between the turbine and the filter, wherein the suction channel can be divided by a separating element into at least a first suction part channel and a second suction part channel, wherein the filter cleaning unit has at least one valve unit for opening or closing the suction part channels. A vacuum cleaner with such a filter cleaning unit, and a method for cleaning a filter of a vacuum cleaner with a filter cleaning unit is also provided. A controllable filter cleaning can be provided, in which the cleaning effect can be reinforced by the advantageous interaction of the filter cleaning unit and its components.

The invention concerns a filter cleaning unit for a vacuum cleaner, in particular a construction site vacuum cleaner, wherein the vacuum cleaner comprises a turbine for generating a suction air flow and a filter for filtering the suction air flow. In further aspects, the invention concerns a vacuum cleaner with such a filter cleaning unit, and a method for cleaning a filter of a vacuum cleaner with a filter cleaning unit.

### BACKGROUND OF THE INVENTION

The prior art includes vacuum cleaning devices which are used, in particular, on construction sites in order to remove dust that is formed in connection with the use of power tools, e.g. drills or grinders. Such “construction site vacuum cleaners” generally comprise a vacuum cleaner head in an upper region and a collecting container for the collected dust in a lower region of the vacuum cleaning device.

### SUMMARY OF THE INVENTION

In the case of known construction-grade vacuum cleaners, the dust is sucked in by means of a turbine, which is driven by means of a motor. In particular, the turbine produces an extraction flow by providing a vacuum in the vacuum cleaning device. As a preferred possibility, the turbine can also be designed as a blower. The turbine or blower is a sensitive component of the vacuum cleaning device, which must be protected especially from dust. Filters or filter elements are therefore usually arranged upstream of the blower or turbine in order to filter any dust remaining in the extraction flow out of the extraction flow before the dust enters the region of the turbine or blower. These filters or filter elements may become clogged with dust over time, and this may impair their functionality.

Conventional construction-site vacuum cleaners that are known from the prior art generally have a filter clearing unit by means of which the filter of the vacuum cleaning device can be cleaned at regular intervals. According to the invention, such filter cleaning is preferably referred to as “filter clearing”. In most cases, a filter cleaning takes place by back-flushing is or by mechanical vibration of the filter. In back-flush solutions, often a valve on the outside of the vacuum cleaner is opened and the filter exposed to an external air flow. The flow direction of this external or back-flush air flow is opposite the flow direction of the suction air flow in suction mode of the vacuum cleaner. Direct application of external air to the filter may however have unfavorable effects on the pressure conditions in the vacuum cleaner, because the pressure in the region of the filter is briefly increased. Also, on direct application of external air to the filter, the filter may be soiled by the unfiltered external air.

It is an object of the present invention to provide a method for cleaning a vacuum cleaner filter, a vacuum cleaner, and a filter cleaning unit, with which the filter can be cleaned efficiently without soiling and in a controlled fashion. In addition, the trade would welcome the provision of a particularly energy-efficient filter cleaning system which minimizes the energy consumption of the vacuum cleaner. The invention is thus particularly suitable for use in battery-powered vacuum cleaners. The invention also provides a particularly robust and compact filter cleaning unit.

The present invention provides a first aspect by a filter cleaning unit for a vacuum cleaner, in particular a construction site vacuum cleaner, wherein the vacuum cleaner comprises a turbine for generating a suction air flow and a filter for filtering the suction air flow. A suction channel is provided between the turbine and the filter, wherein the suction channel can be divided by a separating element into at least a first suction part channel and a second suction part channel, wherein the filter cleaning unit has at least one valve unit for opening or closing the suction part channels.

By the provision of the separating element inside the suction channel, and by the valve unit which is configured to open or close the suction part channels, a filter cleaning unit may be provided in which mutually different pressures or pressure conditions can be set in the different part regions, which in the sense of the invention are preferably called suction part channels. The valve unit can actively control or set the pressures and pressure conditions in the part regions of the suction channel between the filter and turbine, and in this way an optimal cleaning can be provided for the filter of the vacuum cleaner or the filter cleaning unit. Tests have shown that the filter cleaning unit and the cleaning method described in more detail below are particularly energy-saving, since the pressure conditions and pressure differences within the vacuum cleaner are efficiently used to move individual components of the filter cleaning unit or return these to their original position. Thus the filter cleaning unit can be used particularly well in battery-powered vacuum cleaners because the invention allows a particularly long suction operation without needing to recharge the energy supply device. The pressure conditions can be set and regulated by suitably arranged and actuated components of the filter cleaning unit such as valves, separating elements and piston elements.

It is preferred in the sense of the invention that the filter cleaning unit comprises a turbine and a filter. Evidently, it may also be preferred if the filter cleaning unit comprises more than one turbine and more than one filter. For example, the filter cleaning unit or the corresponding vacuum cleaner may comprise two turbines or two filters. The vacuum cleaner may for example also comprise more than one filter cleaning unit, for example two. If the vacuum cleaner comprises two filter cleaning units and two filters, a dividable suction channel may be provided for each filter, in which channel the pressure conditions can be set as described to allow an improved filter cleaning.

The filter cleaning unit may constitute a closed unit in the vacuum cleaner which may for example be surrounded by a housing. The filter cleaning unit has a suction channel which extends between the turbine of the vacuum cleaner and its filter. At least one separating element is provided in the suction channel, wherein the at least one separating element is configured to divide the suction channel into at least two part regions, wherein in the sense of the invention, these part regions are preferably known as “suction part channels”. In a preferred embodiment of the invention, a first upper suction part channel may be formed, and a second lower suction part channel. The second suction part channel preferably constitutes the shortest and most direct connection between turbine and filter, while the connection path between the turbine and filter via the first suction part channel is slightly longer. On its underside, the filter cleaning unit has the filter which must be cleaned from time to time to guarantee a good suction power of the vacuum cleaner and a good filtering effect of the filter. The filter is arranged between the filter cleaning unit and a dirt collection container, wherein the filter preferably closes the dirt collection container at the top. The dirt collection container may have an opening, wherein a suction hose may be connected to the opening. When the turbine of the vacuum cleaner is switched on, the turbine generates a vacuum via which dust from the vicinity of the vacuum cleaner can be sucked in through the suction hose. The majority of the dust remains in the dirt collection container, while a small portion of the dust is carried further by the suction air flow. The suction air flow generated by the turbine flows from the dirt collection container through the filter towards the turbine. The filter may become clogged by the portion of the dust which remains in the suction air flow and has not settled in the dirt collection container, so an undesired filter cake forms. Such dirt residue, residual dust particles and filter cake must be removed from the filter of the vacuum cleaner during a filter cleaning, so that they fall into the dirt collection container of the vacuum cleaner for later disposal in accordance with applicable standards.

The filter cleaning unit may also have a piston element which is described in more detail below. The piston element is configured to carry out an upward and downward movement inside the filter cleaning unit, wherein the piston element is in a rest position during the suction operation of the vacuum cleaner and is transferred from the rest position into a filter cleaning position during filter cleaning. The movement of the piston element between the rest position and filter cleaning position may evidently also be a forward and backward movement or any other type of movement, depending on the arrangement of the filter cleaning unit in the vacuum cleaner and the components in the filter cleaning unit. The rest position preferably lies at the height of the separating element of the filter cleaning unit, while the filter cleaning position preferably lies in the physical vicinity of the filter. The piston element may comprise stop elements which support the piston elements in assuming the rest position or filter cleaning position. The stop elements may for example comprise an elastic material or be made from an elastic material. Preferably, the piston element has stop elements on its top side and underside. The upward and downward movement of the piston element is achieved by a linear or axial guide which runs between the filter of the vacuum cleaner and a top side of the filter cleaning unit. The linear guide preferably runs vertically inside the filter cleaning unit, i.e. substantially perpendicularly to the filter or top side of the filter cleaning unit.

The filter cleaning unit may also have an external opening which connects the filter cleaning unit to an environment of the vacuum cleaner. The external opening may be provided in a housing of the filter cleaning unit or on an outer wall of the vacuum cleaner. In any case, the external opening connects the interior of the vacuum cleaner or filter cleaning unit to the environment of the vacuum cleaner, so that ambient air can penetrate into the vacuum cleaner or filter cleaning unit when an external valve, which closes the external opening, is opened. The external opening in particular lies in a part region of the filter cleaning unit which is on the pressure side of the turbine. In the sense of the invention, this preferably means that the external opening is preferably arranged outside the suction region between the turbine and filter. In the sense of the invention, it is preferred if the external opening is closed during suction operation of the vacuum cleaner, while the external opening can be opened to start a cleaning process for the filter of the vacuum cleaner. The external opening can preferably be opened by the opening of the external valve which closes the external opening during suction operation of the vacuum cleaner. Thus ambient air, which in the sense of the invention is preferably also called external or working air, can flow into the interior of the vacuum cleaner or filter cleaning unit.

The inflow of ambient air is preferably sudden, since a reduced pressure of e.g. 100 mbar prevails in the vacuum cleaner during suction operation. The pressure is at least partially compensated by the opening of the external opening. Under the force of the inflowing external air, the piston element is moved from its rest position into the filter cleaning position, as will be described in more detail below. The piston element thus passes over the second suction part channel so that the suction connection between the turbine and the filter of the vacuum cleaner is separated. This separation of the suction connection between turbine and filter is preferably described as “decoupling” in the sense of the invention. The piston element is in its filter cleaning position between the filter and turbine, so that it interrupts the suction connection between turbine and filter and thus fluidically separates or decouples the turbine and filter from one another. In particular, in its filter cleaning position, the piston element fluidically separates the filter from the remaining filter cleaning unit and the pressures or pressure conditions prevailing there. Thus during filter cleaning, the filter is substantially not exposed to either a reduced pressure or a positive pressure, and the filter can be cleaned with little force, in a particularly simple and uncomplicated fashion. The virtual absence of pressure on the filter means that the filter cake can be separated from the filter more easily. Advantageously, the filter cake can be flushed away substantially without counter force.

The sudden inflow of external air accelerates the piston element in the direction of the filter so that a cushion of compressed air forms on its underside, wherein this air cushion is also accelerated in the direction of the filter. The air cushion reaches the filter and exerts a cleaning pulse on the filter which leads to a mechanical vibration and hence cleaning of the filter. As well as vibration, the air flows through the filter in the reverse flow direction. Thus the invention advantageously allows a suitable combination of mechanical vibration and flushing of the filter with filtered process air, whereby a substantially improved filter cleaning can be provided. Since the external air does not substantially act on the filter, but rather the external air is used to accelerate the piston element, in the context of the present invention the term “indirect cleaning pulse” is preferred; this constitutes a deviation from the prior art and allows cleaning of the filter with filtered working air instead of unfiltered external air.

The piston element may be returned from its filter cleaning position to its rest position if the valve element is switched and closes the second suction part channel, which is open during suction operation of the vacuum cleaner, while opening the first suction part channel, which is closed during suction operation. Thus the pressure conditions in the filter cleaning unit change such that the pressure in the first suction part channel falls, since a vacuum is generated by the suction power of the turbine which is now connected to the first suction part channel. The pressure in the second suction part channel however rises since the second suction part channel is no longer connected to the vacuum-generating turbine. These modified pressure conditions lead to the piston element being raised and conveyed back from the filter cleaning position to the rest position. This upward movement of the piston element is promoted both by the rising pressure in the second suction part channel and also by the strengthening vacuum in the first suction part channel. The strengthening vacuum in the first suction party channel substantially pulls the piston element “upward” in the spatial direction, i.e. raises it, while the piston element is also pushed upward in the spatial direction, i.e. away from the filter, by the rising pressure in the second suction part channel. The stop element of the piston element preferably ensures that the piston element can resume its rest position at the height of the separating element of the filter cleaning unit. Evidently, depending on design of the filter cleaning unit, the piston element may also preferably move in any other spatial direction.

It is preferred in the sense of the invention if the suction part channels are opened and closed alternately, so that in each case one suction part channel is open and the other suction part channel is closed. It is an essential advantage of the invention that because of the targeted or temporally offset switching, i.e. opening and closing, of the valve unit or its components, an optimal sequence of filter cleaning steps can be achieved. In particular, the invention offers the possibility of dividing the suction channel of the filter cleaning unit or vacuum cleaner, which preferably extends between filter and turbine, into different part regions which, in the sense of the invention, are preferably called “suction part channels”. Thus, advantageously, mutually different pressure conditions can be set in the part regions, and thus an optimal filter cleaning achieved. In particular, in this way a controllable filter cleaning can be provided. It is preferred in the sense of the invention that, during suction operation of the vacuum cleaner, the second suction part channel is substantially open while the first suction part channel is substantially closed.

Preferably, the at least one valve unit may consist of two or more components which are formed by a first individual valve and a second individual valve, wherein the individual valves can be controlled independently of one another. The phrase that the “individual valves of the at least one valve unit can be controlled independently of one another” means that, in principle, these are mutually independent i.e. separate individual valves, wherein each individual valve is assigned to a suction part channel. In other words, a first individual valve may be assigned to the first suction part channel while a second individual valve may be assigned to the second suction part channel. Preferably, the first individual valve may be configured to open or close the first suction part channel, while the second individual valve is configured to open or close the second suction part channel. In the context of the present invention, the individual valves are however controlled in synchrony, such that in each case one individual valve is open while the other is closed. By this synchronous actuation of the individual valves, which form the valve unit in this embodiment of the invention, advantageously the alternate opening and closing of the at least two channels can be achieved, so that the optimized and controllable filter cleaning according to the present invention can be provided.

In another preferred embodiment of the invention, the at least one valve unit is formed by a first flat element and a second flat element, wherein the flat elements are connected together via a common shaft. The flat elements are preferably rigidly connected to the common shaft so that the flat elements move jointly when for example the common shaft is turned. The common shaft is in particular rotatable. By connecting the flat elements via the common shaft, the movement of the flat elements is synchronized. Each of the two flat elements is preferably assigned to one of the at least two suction part channels. In other words, a first flat element may be assigned to the first suction part channel while a second flat element may be assigned to the second suction part channel. Preferably, the first flat element may be configured to open or close the first suction part channel, while the second flat element is configured to open or close the second suction part channel. The suction part channels are opened and/or closed depending on the relative arrangement of the flat elements on the common shaft. If the flat elements are for example offset to one another by substantially 90°, the common shaft of the valve unit may be turned such that a suction part channel is substantially completely closed because the corresponding flat element assigned to said suction part channel substantially completely closes the corresponding suction part channel. In this embodiment of the invention, for the described position of the common shaft and arrangement of the flat elements offset to one another substantially by 90°, the other suction channel may be substantially completely open because the corresponding flat element assigned to said other suction part channel lies flat in the suction part channel and does not obstruct or scarcely obstructs an air flow through the suction part channel. The flat elements are preferably arranged as flaps in a plane, so that they close a suction part channel when the plane, which may be formed by the flat elements, substantially completely seals a cross-section of the respective suction part channel. If the flat elements stand in the suction part channel at substantially 90° to this closed position, advantageously almost the entire cross-section of the suction part channel is open because the flat elements lie substantially horizontally in a centre plane of the respective suction part channel and thus do not constitute a resistance to the through-flowing suction air flow.

Mathematically, the opening degree of the two part channels, with flat elements offset to one another by substantially 90°, can be described by two sine curves which run offset to one another by substantially 90°. In the above exemplary embodiment, the fully closed suction part channel corresponds to a zero point of the corresponding sine curve, and the opening angle of the flat elements relative to a virtual central axis or centre plane in the corresponding suction part channel lies at substantially 0°. The sine curve running offset thereto by substantially 90°, which describes the opening degree of the other suction part channel, has a maximum in this position of the common shaft, because in this position of the common shaft and flat elements, the suction part channel is maximally open.

In the sense of the invention, it may be preferred that the at least one valve unit is formed by an individual valve, wherein the individual valve is present in at least a first position and a second position, and wherein in the first position, the individual valve opens the first suction part channel and closes the second suction part channel, and wherein in the second position, the individual valve opens the second suction part channel and closes the first suction part channel. The individual valve may also assume a third position in which the individual valve at least partially opens both the first and second suction part channels.

In the sense of the invention, it is preferred that the filter cleaning unit comprises a piston element, wherein the piston element can be moved from a rest position in the direction of the filter of the filter cleaning unit by the introduction of ambient air through an external opening of the filter cleaning unit. Preferably, the piston element may be moved or accelerated from a rest position in the direction of the filter of the filter cleaning unit by the introduction of ambient air through an external opening in the housing of the filter cleaning unit. The ambient air used to accelerate the piston element may be referred to preferably as working air in the sense of the invention. In comparison with conventional filter cleaning methods, with the present invention, the filter is not exposed to unfiltered external air but to working air from the interior of the vacuum cleaner.

During suction operation of the vacuum cleaner, the piston element is preferably at the height of the separating element inside the filter cleaning unit. In suction operation, for example the second suction part channel may be open so that a suction flow is generated by the turbine and flows from the filter in the direction of the turbine. During suction operation of the vacuum cleaner, the first suction part channel is preferably closed. For the various embodiments of the valve unit, this means that during suction operation, in the case of two individual valves, the first upper individual valve is closed while the second lower individual valve is open. In the case that the valve unit comprises flat elements connected together via a common shaft, the first upper flat element lies in the first suction part channel so as to substantially completely close this, while the second lower flat element lies in the second suction part channel so as to substantially completely open this. In the case that the valve unit has an individual valve which may be present in at least two positions, during suction operation of the vacuum cleaner, the individual valve is present in its second position in which the individual valve opens the second suction part channel and closes the first suction part channel.

The position of the valve unit, or the position and arrangements of the elements of the valve unit, in suction operation ensures that a suction air stream flows from the filter towards the turbine. This flow path is not blocked by the piston element since the piston element is arranged at the height of the separating element, wherein the separating element is configured to divide or separate the suction channel into the individual suction part channels. The position of the piston element at the height of the separating element of the filter cleaning unit, in the sense of the invention, is preferably also called the starting or rest position of the piston element.

If a filter cleaning is now to be performed, ambient air may be introduced through an external opening in the housing of the filter cleaning unit. Since a reduced pressure prevails in the interior of the filter cleaning unit or in the interior of the vacuum cleaner, the opening of an external opening draws a large surge of external air into the vacuum cleaner or filter cleaning unit with high force. This surge of external air presses the piston element from its starting position in a “downward” spatial direction, i.e. in the direction of the filter of the filter cleaning unit or dust collection container. At its sides, the piston element lies closely against the inner walls of the housing of the filter cleaning unit, so that the sudden movement of the piston element towards the filter creates a cushion of compressed air, wherein this air cushion is pressed or pushed by the piston element in the direction of the filter. The accelerated cushion of compressed air may exert a pressure pulse on the filter so that the filter is mechanically vibrated when the air cushion reaches the filter. This mechanical vibration releases or knocks off any existing dust or filter cake from the filter, so that the filter is cleaned. The released dust and filter cake may fall into the dust collection container of the vacuum cleaner, wherein the dust collection container of the vacuum cleaner is preferably arranged below the filter and therefore ideally suited to receiving the dust and filter cake.

In the sense of the invention, it may be preferred that the cleaning method constitutes a combination of mechanical vibration and back-flushing of the filter, wherein for back-flushing of the filter, advantageously not external air but filtered process air from the interior of the vacuum cleaner is used. In the sense of the invention however, it may also be preferred that the piston element does not touch the filter, so no mechanical cleaning takes place in the sense that an object knocks or shakes the filter. Instead, the filter is mechanically vibrated by the air cushion, wherein the air cushion is accelerated by the rapid surge inflow of external air and the resulting sudden movement of the piston element towards the filter, so that the air cushion can exert a strong pulse effect on the filter.

In the sense of the invention, it is preferred that the ambient air flowing in through the external opening of the vacuum cleaner is used to accelerate the piston element, and not used as flushing air for the filter of the vacuum cleaner as in many vacuum cleaners known from the prior art.

The piston element rather comes to a standstill in a filter cleaning position after its sudden movement. The piston element may for example be guided by a central linear guide, wherein the central linear guide ensures the upward and downward movement of the piston element. The piston element may have stop elements arranged around the central linear guide, which may establish the filter cleaning position of the piston element. The stop elements may define a distance between the filter and the underside of the piston element, wherein the piston element comes to a standstill at this distance from the filter, where it assumes its filter cleaning position.

During the sudden downward movement of the piston element from its rest or filter cleaning position, the piston element passes over the second suction part channel so that the filter and turbine are thereby fluidically decoupled from one another. In other words, after the decoupling of turbine and filter, there is no further suction flow between filter and turbine, wherein such a decoupling can substantially improve the filter cleaning effect of the accelerated cushion of compressed air. Thus the design of the filter cleaning unit, and the arrangement and interaction of its components, ensure a synergy of several effects which allow optimal cleaning of a filter in a vacuum cleaner. Firstly, the filter is cleaned by the cushion of compressed air from the introduction of external air and the resulting downward movement of the piston element. Secondly, this cleaning is advantageously supported in that the downward movement of the piston element ensures a decoupling of turbine and filter, which considerably simplifies the performance of filter cleaning and greatly increases the filter cleaning effect.

The method and the filter cleaning unit provided are characterized in that no external air is used to load and flush or back-flush the filter of the vacuum cleaner. Rather, in the context of the present invention, the external air is used to greatly accelerate a piston element from a rest position, so as to form an air cushion which in turn causes a mechanical vibration of the filter. For the purposes of the invention, it is preferred that the external air does not itself come into contact with the filter. This is achieved by the close contact of the piston element with the inner walls of the housing of the filter cleaning unit. The sealing effect of the close contact may be further improved by the provision of sealing means such as sealing lips or similar. In this case, the sealing means may be arranged on the outer sides of the piston element in order to seal the suction channel above the filter against the top side of the piston element and prevent contact between the external air and the filter. In the context of the invention, such sealing means are known as radial sealing means. However, axial sealing means may also be provided to allow a high dynamic and create a sealing effect in the piston end positions. The phrase “high dynamic” in the sense of the invention preferably means that the piston element can be rapidly accelerated by the inflowing external air. In particular, this is achieved in that axial sealing means are used, which generate no friction between the piston element and side walls of the filter cleaning unit. The sealing effect of the axial sealing means in the end positions of the piston element may ensure a particularly good fluidic decoupling of the filter from the turbine of the vacuum cleaner. The piston is in the end position in particular when the piston element is in the filter cleaning position.

The present filter cleaning unit and the method are preferably characterized by a direct fluidic connection between the filter and the turbine when the vacuum cleaner is in suction operation and the second suction part channel is open.

Because of this direct fluidic connection between filter and turbine in suction operation of the vacuum cleaner, and because the filter is not loaded or flushed with external air, the invention deliberately deviates from the prior art in which the filter of the vacuum cleaner is usually loaded with external air for flushing and hence cleaning this. In the context of the present invention, the rapidly entering external air is advantageously used to accelerate the piston element towards the filter so that the piston element moves suddenly in the direction of the filter and forms the air cushion of compressed process air which causes the mechanical vibration of the filter. The term “process air” in this sense of the invention means the air which is present or lies in the interior of the vacuum cleaner. The process air is not the same as the external air penetrating into the vacuum cleaner through the external opening from the vicinity of the vacuum cleaner, which is used to accelerate the piston element in the direction of the filter of the vacuum cleaner.

It is preferred in the context of the invention that the external opening of the filter cleaning unit has an external valve, wherein the external valve is configured to open or close the external opening of the filter cleaning unit. For the purposes of the invention, it is preferred also to called the external valve a working valve of the filter cleaning unit.

In the sense of the invention, it is also preferred that the filter cleaning process is started by opening the external opening of the filter cleaning unit. The external opening of the filter cleaning unit may have an external or working valve, wherein the external valve is configured to open or close the external opening of the filter cleaning unit. In suction operation of the vacuum cleaner, the external valve is preferably closed so that no external air can penetrate into the filter cleaning unit or vacuum cleaner. This is important because a reduced pressure prevails in the filter cleaning unit or vacuum cleaner, which is used to draw dust, dirt or mud through a suction hose into the interior of the vacuum cleaner. The dust, dirt or mud may collect then in a dirt or dust collection container and be retained until the next evacuation of the dirt or dust collection container. The vacuum which prevails during suction operation of the vacuum cleaner is preferably generated by the turbine. The turbine may preferably be driven by a motor, preferably an electric motor. The vacuum cleaner may preferably be supplied with electrical energy via a grid connection. In the sense of the invention, it may also be preferred that the vacuum cleaner is a battery-powered vacuum cleaner and is supplied with electrical energy by a rechargeable energy supply device.

If dirt has caught in the filter and perhaps a solid filter cake has formed in the filter of the vacuum cleaner, disadvantageously the suction power of the vacuum cleaner may be reduced. Therefore filter cleaning should be performed at regular intervals to clear the filter of dust, dirt, mud or solidified filter cake.

This filter cleaning may be initiated by opening the external valve, wherein the penetration of external air can accelerate the piston element in the interior of the filter cleaning unit in the direction of the filter. In other words, the external opening of the filter cleaning unit may be opened to begin a filter cleaning or filter cleaning process.

In the sense of the invention, it is preferred that the piston element is returned to its rest position by actuation of the valve unit. Preferably, the piston element may be returned to its rest position by an opening of the first suction part channel and by a closing of the second suction part channel. In particular, the piston element is returned from its filter cleaning position to its rest position by the closure of the second suction part channel, which is open during suction operation of the vacuum cleaner, and the opening of the first suction part channel, which is closed during suction operation of the vacuum cleaner.

It is preferred in the sense of the invention that the filter cleaning unit comprises a magnet, wherein the magnet is configured to hold the piston in its rest position. The magnet may for example be configured as a permanent magnet in order to save energy. However, a design as an electromagnet is also conceivable.

For the various embodiments of the valve unit, this means that, in the case that the valve unit comprises two individual valves, the first upper individual valve is open while the second lower individual valve is closed. In the case that the valve unit comprises flat elements connected together via a common shaft, the common shaft is turned such that the first upper flat element lies in the first suction part channel so as to substantially completely open this, while the second lower flat element lies in the second suction part channel so as to substantially completely close this. In the case that the valve unit has an individual valve which may be present in at least two positions, during cleaning of the at least one filter of the vacuum cleaner, the individual valve is present in its first position in which the individual valve opens the first suction part channel and closes the second suction part channel.

After penetration of the external air into the filter cleaning unit, and after the downward movement of the piston element towards the filter, the piston element lies in its filter cleaning position, i.e. In the physical vicinity of the filter, wherein a distance between the piston element and filter may be established by stop elements of the piston element. Depending on the design of the filter cleaning unit, the piston element may thus be arranged in the filter cleaning position such that the piston element moves forward and back, e.g. sideways.

When the second suction part channel is closed for filter cleaning and the first suction part channel opened for filter cleaning, the pressure conditions in the suction channel change as follows: By the switching of the valve unit and the opening of the first suction channel, the pressure in the first suction part channel falls while the pressure in the second suction part channel rises due to the absence of suction from the turbine.

The strengthening vacuum in the first suction part channel and the rising pressure in the second suction part channel lift the piston element, wherein the latter is effectively sucked by the vacuum in the first suction part channel, and thereby moved back to its rest position. The piston element may also have stop elements on its top side which, in cooperation with the central linear guide of the piston element, ensure that the piston element can assume its rest position at the height of the separating element between the suction part channels.

In a second aspect, the invention relates to a vacuum cleaner with a filter cleaning unit according to the invention. In a further aspect, the invention relates to a method for cleaning a filter of such a vacuum cleaner, wherein the method is characterized by the following steps:
a) provision of a vacuum cleaner according to the invention,
b) operation of the vacuum cleaner, wherein in a suction operation of the vacuum cleaner, the first suction part channel is closed and the second suction part channel is open, and wherein in a suction operation of the vacuum cleaner, a piston element is present in a rest position,
c) starting of a filter cleaning process by opening an external opening of the vacuum cleaner so that ambient air can penetrate into the vacuum cleaner,
d) generation of an indirect cleaning pulse by the inflowing ambient air,
e) cleaning of the filter of the vacuum cleaner by the indirect cleaning pulse.

With the cleaning method, an effective, powerful and as-needed filter cleaning can be provided which in particular is controllable. A particular advantage of the invention is that the components of the filter cleaning unit are arranged highly suitably relative to one another, and cooperate well in order to make optimum use of the various movements of the components and the resulting changes in position and pressure in order to provide an improved filter cleaning for a filter of a vacuum cleaner, in particular a construction site vacuum cleaner. The definitions, technical effects and advantages that have been described for the filter cleaning unit apply analogously to the filter cleaning method and the vacuum cleaner, which has a filter cleaning unit according to the invention.

In the sense of the invention, it is preferred that for performance of the above cleaning method, the vacuum cleaner has a piston element, wherein the piston element lies in a rest position in a suction operation of the vacuum cleaner, and can be transferred from the rest position into a filter cleaning position by inflowing ambient air, wherein the movement of the piston element causes the indirect pulse for cleaning the filter. Preferably, the piston element may be returned to its rest position from the filter cleaning position by an opening of the first suction part channel and by a closing of the second suction part channel.

It is preferred in the sense of the invention that the vacuum cleaner reverts to a suction operation when the first suction part channel is closed and the second suction part channel opened. Preferably, in this way, the piston element may also be returned from the filter cleaning position to the rest position in order to allow renewed suction operation of the vacuum cleaner and terminate the filter cleaning process.

According to the invention, it is preferred that the piston element comprises at least one piston or is formed by at least one piston. According to the invention, it is also preferred that the valve unit comprises at least one valve or is formed by at least one valve. In addition, the separating element may comprise at least one separating object such as a partition wall, or be formed by at least one separating object such as a partition wall. The flat elements which form the valve unit in a preferred embodiment of the invention may comprise flat objects or be formed by flat objects. They may preferably be rotatable flaps which are connected together via a common shaft and are arranged in the suction part channels.

Further advantages will become apparent from the following description of the figures. Various exemplary embodiments of the present invention are shown in the figures. The figures, the description and the claims comprise numerous features in combination. A person skilled in the art will expediently also consider the features individually and combine them to produce useful further combinations.

### BRIEF DESCRIPTION OF THE DRAWINGS

Identical and similar components are denoted by the same reference signs in the figures,

In the drawings:

FIG. 1 shows a schematic side view of a preferred embodiment of the filter cleaning unit with a valve unit comprising two individual valves,

FIG. 2 shows a schematic side view of a preferred embodiment of the filter cleaning unit with a valve unit comprising two flat elements,

FIG. 3 shows a schematic side view of a preferred embodiment of the filter cleaning unit with a valve unit comprising an individual valve which may be present in two positions.

### DETAILED DESCRIPTION

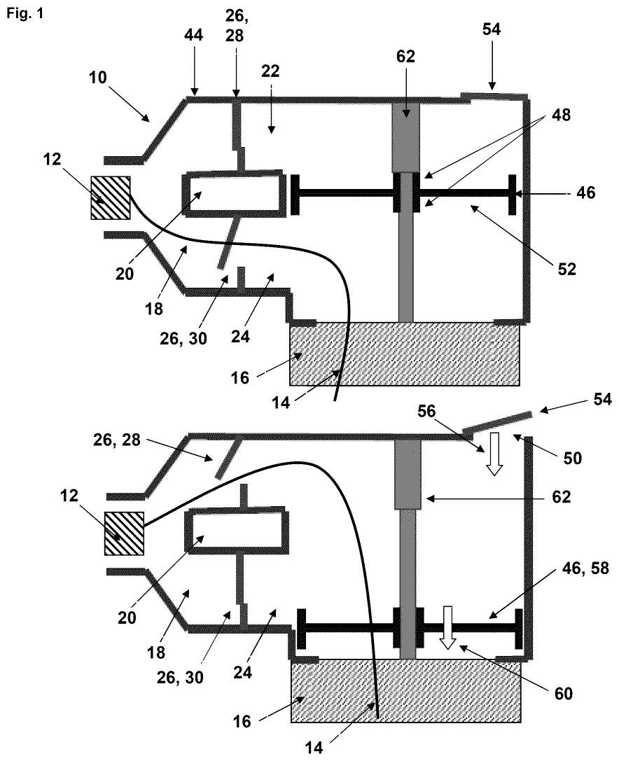

FIG. 1 shows a side view of a preferred embodiment of the filter cleaning unit 10 with a valve unit 26 comprising two individual valves 28, 30. The filter cleaning unit 10 has a turbine 12 and a filter 16, wherein the turbine 12 can generate a suction air flow 14 which flows from a dirt collection container of the vacuum cleaner in the direction of the turbine 12. The upper part of FIG. 1 shows the filter cleaning unit 10 in a suction operation of the vacuum cleaner, wherein in suction operation, the first individual valve 28 of the valve unit is closed and the second individual valve 30 of the valve unit 26 is open. The suction air flow 14 thus flows through the second suction part channel 24 from the filter 16 towards the turbine 12. The second suction part channel 24 preferably constitutes the shortest flow path and the most direct connection between the turbine 12 and filter 16. The space between the turbine 12 and filter 16 is called the suction channel 18, wherein the suction space 18 can be divided by a separating element 20 into individual part regions 22, 24. In the exemplary embodiment of the invention shown in FIG. 1, the first suction part channel 22 and second suction part channel 24 form the part regions of the suction channel 18 between the turbine 12 and filter 16 of the filter cleaning unit 10. The filter cleaning unit 10 may be surrounded by a housing 44.

In the suction operation of the vacuum cleaner shown in the top half of FIG. 1, an external valve 54 of the filter cleaning unit 10 is closed. The external valve 54 closes an external opening 50 present in the housing 44 of the filter cleaning unit 10 or on an outer wall of the vacuum cleaner, and creates a fluidic connection between the interior of the vacuum cleaner or filter cleaning unit 10 and the environment of the vacuum cleaner.

The filter cleaning unit 10 also has a piston element 46 which can carry out an upward and downward movement along a linear guide 62. The linear guide 62 may preferably also be referred to as an axial guide. The linear or axial guide 62 may be arranged centrally relative to the piston element 46. However, it may also be preferred in the context of the invention for the linear guide 62 to be formed by lateral guides. The piston element 46 may comprise stop elements 48 which can stop an upward or downward movement of the piston element 46. In the suction operation of the vacuum cleaner shown in the top half of FIG. 1, the piston element 46 is in a rest position 52, wherein the rest position 52 lies approximately at the height of the separating element 20 of the filter cleaning unit 10.

The lower half of FIG. 1 shows a situation during cleaning of the filter 16 of the vacuum cleaner. A filter cleaning process may be initiated by opening the external valve 54 so that ambient air 56 flows into the interior of the vacuum cleaner or filter cleaning unit 10. The inflowing ambient air 56 moves the piston element 46 from its rest position 52 into a filter cleaning position 58, wherein this movement is sudden because of the force of the inflowing ambient air 56. The sudden downward movement of the piston element 46 generates a cleaning pulse 60 which acts on the filter 16 and cleans the filter 16. In particular, in its downward movement towards the filter 16, the piston element 46 pushes before it an air cushion which causes the cleaning of the filter 16, wherein the cleaning pulse 60 in particular causes a mechanical vibration or through-flow of the filter 16 in the direction of the dust collection container.

In the downward movement of the piston element 46 and its resulting position change from the rest position 52 to the filter cleaning position 58, the piston element 46 passes over the second suction part channel 24 so that the filter 16 is fluidically decoupled from the turbine 12. Thus the cleaning effect can be further improved.

The piston element 46 may be conveyed back into its rest position 52 at the height of the separating element 20 of the filter cleaning unit 10 by a switching of the valve unit 26. Here, the first individual valve 28 of the valve unit 26 is opened and thereby the first suction part channel 22 opened, while the second individual valve 30 of the valve unit 26 is closed and thereby the second suction part channel 24 closed. As can be seen in the lower half of FIG. 1, turbine 12, via channel 22, then can pull piston element 46 back to rest position 52.

Although the figures do not show a fluidically complete decoupling of the filter 16 and turbine 12, in the sense of the invention it is preferred that the filter 16 is substantially completely fluidically decoupled, i.e. separated, from the turbine 12 and the suction channel 18. For this, the gap visible in the figures, present between the piston element 46 and housing 44 of the filter cleaning unit 10 in the filter cleaning position 58 of the piston element 46, can be sealed or closed by corresponding sealing means.

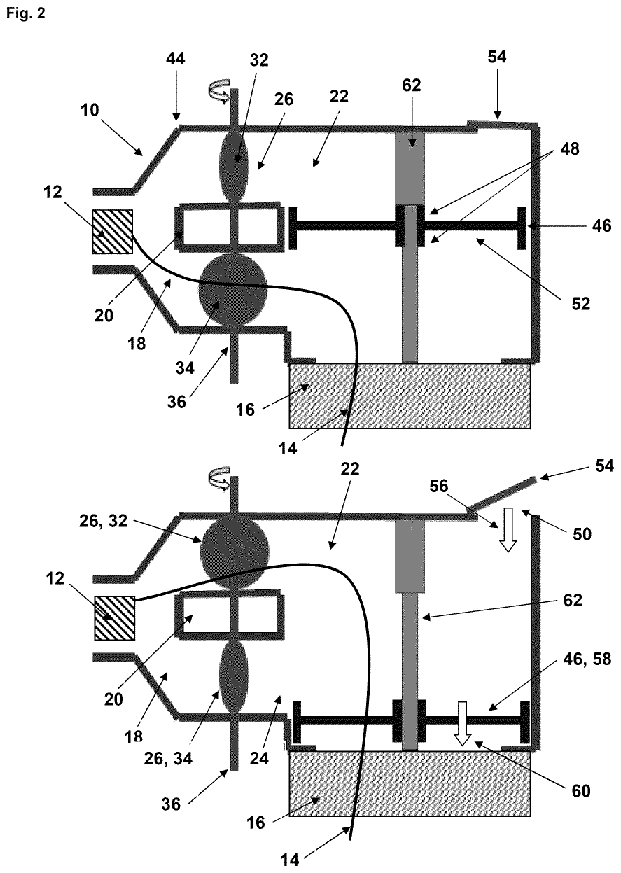

FIG. 2 shows a schematic side view of a preferred embodiment of the filter cleaning unit 10 with a valve unit 26 comprising two flat elements 32, 34. The top image half again shows the suction operation of the vacuum cleaner, while the lower image half shows a situation during cleaning of the filter 16 of the vacuum cleaner. The valve unit 26 shown in FIG. 2 has a first flat element 32 and a second flat element 34, wherein the flat elements 32, 34 are connected together via a common shaft 36. In the upper image half showing the suction operation of the vacuum cleaner, the first flat element 32 of the valve unit 26 lies in the first suction part channel 22 such that it substantially completely closes this. In the second suction part channel 24, the second flat element 34 is arranged horizontally so that it substantially opens the second suction channel 24, and the suction air flow 14 can flow through the second suction part channel 24 from the filter 16 to the turbine 12.

In the lower image half showing a situation during cleaning of the filter 16 of the vacuum cleaner, the first flat element 32 of the valve unit 26 lies in the first suction part channel 22 so that it substantially completely opens this. In the second suction part channel 24, the second flat element 34 is arranged horizontally so that it substantially closes the second suction channel 24. The suction air flow 14 now flows through the first suction part channel 22 from the filter 16 to the turbine 12. The common shaft 36 of the valve unit 26 is preferably rotatably mounted, while the flat elements 32, 34 are rigidly connected to the common shaft 36. A movement, i.e. rotation, of the common shaft 36 preferably leads to a joint movement of the two flat elements 32, 34 in the valve unit 26 shown in FIG. 2.

The function of the external valve 54 and piston element 46 in the exemplary embodiment of the invention shown in FIG. 2 corresponds to the function which has already been described with respect to FIG. 1.

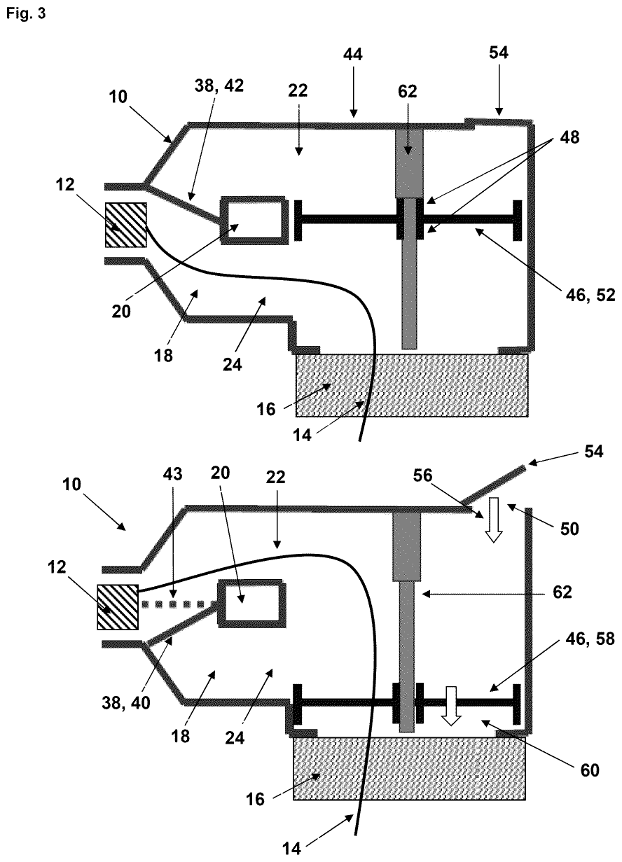

FIG. 3 shows a schematic side view of a preferred embodiment of the filter cleaning unit 10 with a valve unit 26 comprising an individual valve 38 which may be present in two positions 40, 42. The top image half of FIG. 3 shows the suction operation of the vacuum cleaner, while the lower image half of FIG. 3 shows a situation during cleaning of the filter 16 of the vacuum cleaner. The valve unit 26 shown in FIG. 3 has an individual valve 38 which can assume at least a first position 40 and a second position 42. The individual valve 38 may also assume a third position 43 in which both suction part channels 22, 24 are at least partially open. In the first position 40 of the individual valve 38, the first suction part channel 22 is open and the second suction part channel 24 closed, while in the second position 42 of the individual valve 38, the first suction part channel 22 is closed and the second suction part channel 24 is open. Thus in the first position 40 of the individual valve 38, the suction air flow 14 can flow through the first suction part channel 22, while in the second position 42 of the individual valve 38, the suction air flow 14 flows through the second suction part channel 24.

The function of the external valve 54 and piston element 46 in the exemplary embodiment of the invention shown in FIG. 3 corresponds to the function which has already been described with respect to FIGS. 1 and 2.

### LIST OF REFERENCE SIGNS

10 Filter cleaning unit
12 Turbine
14 Suction air flow
16 Filter
18 Suction channel
20 Separating element
22 First suction part channel
24 Second suction part channel
26 Valve unit
28 First individual valve
30 Second individual valve
32 First flat element
34 Second flat element
36 Common shaft
38 Individual valve
40 First position
42 Second position
43 Third position
44 Housing of the filter cleaning unit
46 Piston element
48 Stop elements
50 External opening
52 Rest position
54 External valve
56 Ambient air
58 Filter cleaning position
60 Cleaning pulse
62 Linear guide

1-15. (canceled)

16: A filter cleaning unit for a vacuum cleaner, the vacuum cleaner having a turbine for generating a suction air flow and a filter for filtering the suction air flow, a suction channel being provided between the turbine and the filter, wherein the suction channel is dividable by a separator into at least a first suction part channel and a second suction part channel, the filter cleaning unit comprising:
at least one valve unit for opening or closing the first and second suction part channels.

17: The filter cleaning unit as recited in claim 16 wherein the filter cleaning unit opens or closes the first and second suction part channels alternately so that in each case, one of the first and second suction part channels is open and the other of the first and second suction part channels is closed.

18: The filter cleaning unit recited in claim 16 wherein during suction operation of the vacuum cleaner, the second suction part channel is substantially open while the first suction part channel is substantially closed.

19: The filter cleaning unit as recited in claim 16 wherein the at least one valve unit is formed by a first individual valve and a second individual valve, wherein the first and second individual valves are controllable independently of one another.

20: The filter cleaning unit as recited in claim 16 wherein the at least one valve unit is formed by a first flat element and a second flat element connected together via a common shaft.

21: The filter cleaning unit as recited in claim 16 wherein the at least one valve unit is formed by an individual valve having at least a first position and a second position, and wherein the individual valve in the first position opens the first suction part channel and closes the second suction part channel, and wherein the individual valve in the second position opens the second suction part channel and closes the first suction part channel.

22: The filter cleaning unit as recited in claim 16 further comprising a piston element movable from a rest position in the direction of the filter of the filter cleaning unit by introduction of ambient air through an external opening of the filter cleaning unit.

23: The filter cleaning unit as recited in claim 22 wherein the external opening of the filter cleaning unit has an external valve configured to open or close the external opening of the filter cleaning unit.

24: The filter cleaning unit as recited in claim 22 wherein the piston element is returned to the rest position by an actuation of the valve unit.

25: The filter cleaning unit as recited in claim 22 wherein the piston element is returned to the rest position by an opening of the first suction part channel and by a closing of the second suction part channel.

26: The filter cleaning unit as recited in claim 22 further comprising a magnet configured to hold the piston element in the rest position.

27: A vacuum cleaner comprising the filter cleaning unit as recited in claim 15.

28: A construction site vacuum cleaner comprising the filter cleaning unit as recited in claim 15.

29: A method for cleaning a filter of a vacuum cleaner as recited in claim 27, the method comprising the following steps:
a) providing the vacuum cleaner as recited in claim 27,
b) operating the vacuum cleaner, wherein in a suction operation of the vacuum cleaner, the first suction part channel is closed and the second suction part channel is open,
c) starting a filter cleaning process by opening an external opening of the vacuum cleaner so that ambient air can penetrate into the vacuum cleaner,
d) generating an indirect cleaning pulse by the inflowing ambient air, and
e) cleaning the filter of the vacuum cleaner by the indirect cleaning pulse.

30: The method as recited in claim 29 wherein the vacuum cleaner has a piston element having a rest position during suction operation of the vacuum cleaner, and transferable from the rest position to a filter cleaning position by inflowing ambient air, wherein movement of the piston element causes the indirect cleaning pulse.

31: The method as recited in claim 30 wherein the piston element is returnable from the filter cleaning position to the rest position by an opening of the first suction part channel and by a closing of the second suction part channel.
